(19) United States
(12) Patent Application Publication
(10) Pub. No.: US 2011/0234653 A1
(43) Pub. Date: Sep. 29, 2011

(54) LIQUID CRYSTAL DISPLAY DEVICE AND METHOD OF OPERATING THE SAME

(75) Inventor: Toshiaki Ueda, Kanagawa (JP)

(73) Assignee: RENESAS ELECTRONICS CORPORATION, Kanagawa (JP)

(21) Appl. No.: 13/073,482

(22) Filed: Mar. 28, 2011

(30) Foreign Application Priority Data
Mar. 29, 2010 (JP) 2010-076181

(51) Int. Cl. G09G 3/36; G09G 5/10; G09G 5/00

(52) U.S. Cl. 345/690; 345/209; 345/89

(57) ABSTRACT

A source driver is supplied with a mode switch signal specifying an applied inversion driving method from among horizontal one-dot inversion driving, first horizontal n-dot inversion driving in which a number of outputs does not disturb regularity of a polarity pattern of data signals, and second horizontal n-dot inversion driving in which a number of outputs disturbs regularity of a polarity pattern of data signals. The source driver supplies data signals to data lines. The polarity pattern of the data signals depends on a polarity signal and the applied inversion driving method specified by the mode switch signal. The source driver supplies the polarity signal to a next source driver in the case of the horizontal one-dot inversion driving or the first horizontal n-dot inversion driving, and supplies the polarity signal whose polarity is inverted to the next source driver in the case of the second horizontal n-dot inversion driving.

### INCORPORATION BY REFERENCE

This application is based upon and claims the benefit of priority from Japanese patent application No. 2010-076181, filed on Mar. 29, 2010, the disclosure of which is incorporated herein in its entirety by reference.

### BACKGROUND OF THE INVENTION

1. Field of the Invention

The present invention relates to a liquid crystal display device that drives a display panel by an inversion driving method, and a method of driving the liquid crystal display device.

2. Description of Related Art

It is known that when a pixel of a display panel is driven in a DC manner, life time of a liquid crystal layer of the pixel is decreased. This phenomenon is called a burn-in phenomenon. A technique widely used for preventing the burn-in phenomenon is “inversion driving (AC driving)”. According to a typical inversion driving method, a polarity of a data signal supplied to a pixel is inverted every one line or every m lines (m is an integer equal to or larger than 2).

A dot inversion driving method is also known as a kind of the inversion driving method. According to the dot inversion driving, the polarity of the data signal is inverted within a single line. The dot inversion driving method includes horizontal one-dot inversion driving and horizontal n-dot inversion driving (n is an integer equal to or larger than 2).

In the case of the horizontal one-dot inversion driving, the polarity of the data signal is inverted every one pixel within a single line. This may cause flicker. On the other hand, in the case of the horizontal n-dot inversion driving, the polarity of the data signal is inverted every n pixels within a single line (n is an integer equal to or larger than 2). In this case, occurrence of the flicker is suppressed.

However, in a case where a display panel is driven by a plurality of source drivers by using the horizontal n-dot inversion driving method, image unevenness may appear in a boundary division between regions that are respectively driven by adjacent source drivers. The image unevenness is caused by disturbance of regularity of a polarity pattern of the data signals around the boundary division. The disturbance of regularity depends on the number of outputs of the source driver, namely, the number of the data signals output from the source driver.

The horizontal n-dot inversion driving in which the number of outputs does not disturb regularity of the polarity pattern of the data signals is hereinafter referred to as “first horizontal n-dot inversion driving”. For example, let us consider a case of the first horizontal n-dot inversion driving where n is 2 and the polarity pattern of the data signals output from a single source driver is “+, −, −, +, +, . . . , −, −,+”. Regarding the boundary division between a first region and a second region adjacent to each other in the display panel, the polarity “+” of the data signal supplied to the last data line in the first region and the polarity “+” of the data signal supplied to the first data line in the second region are the same. Therefore, the first horizontal n-dot inversion driving does not disturb regularity of the polarity pattern of the data signals.

The horizontal n-dot inversion driving in which the number of outputs disturbs regularity of the polarity pattern of the data signals is hereinafter referred to as “second horizontal n-dot inversion driving”. For example, let us consider a case of the second horizontal n-dot inversion driving where n is 2 and the polarity pattern of the data signals output from a single source driver is “+, −, −, +, +, . . . , +, +, −”. Regarding the boundary division between a first region and a second region adjacent to each other in the display panel, the polarity “−” of the data signal supplied to the last data line in the first region and the polarity “+” of the data signal supplied to the first data line in the second region are different from each other. Therefore, the second horizontal n-dot inversion driving causes disturbance of regularity of the polarity pattern of the data signals.

It is therefore desirable to resolve the disturbance of regularity of the polarity pattern of the data signals even if the second horizontal n-dot inversion driving is executed.

Japanese Patent Publication JP-2006-47878 (Patent Literature 1) discloses a liquid crystal display device. The liquid crystal display device has: a plurality of source drivers that are cascade-connected; a display panel that is divided into a plurality of regions whose number is equal to the number of the plurality of source drivers; and a controller.

As an example, in the case of the second horizontal n-dot inversion driving, the number of outputs of each source driver is a number that is not divisible by 4 and thus disturbs regularity of the polarity pattern of the data signals. The n is equal to 2.

The controller supplies gray-scale data, a clock signal and a polarity signal to each of the plurality of source drivers. The gray-scale data specifies respective gray-scale levels of a plurality of pixels in a corresponding region of the plurality of regions. The clock signal is used for synchronizing the plurality of source drivers. In the case of the second horizontal two-dot inversion driving, a polarity of the polarity signal specifies the polarity pattern (“+, −, −, +, +, . . . , +, +, −” or “−, +, +, −, −, . . . , −, −, +”) of the data signals with respect to each line.

The controller supplies a shift start signal including a first control signal (a pulse width of a shift start pulse is one of one cycle and two cycles of the clock signal) to a first source driver of the plurality of source drivers.

In response to the shift start signal supplied from the controller, the first source driver takes the gray-scale data supplied from the controller and converts, based on a plurality of gray-scale voltages, the gray-scale data into output gray-scale voltages as the data signals output from the first source driver.

Next, the first source driver supplies the data signals respectively to a plurality of data lines in a first region of the plurality of regions. In the case of the second horizontal two-dot inversion driving, the polarity pattern of the data signals is “+, −, −, +, +, . . . , +, +, −” or “−, +, +, −, −, . . . , −, −, +” which is specified by the polarity signal supplied from the controller. In the case where the shift start signal includes the first control signal, the data signals whose polarity pattern is the same as that specified by the polarity signal are supplied to the plurality of data lines.

Moreover, the first source driver supplies a shift start signal including a second control signal (a pulse width of a shift start pulse is the other of one cycle and two cycles of the clock signal) to a second source driver of the plurality of source drivers that is adjacent to the first source driver.

In response to the shift start signal supplied from the first source driver, the second source driver takes the gray-scale data supplied from the controller and converts, based on the plurality of gray-scale voltages, the gray-scale data into output gray-scale voltages as the data signals output from the second source driver.

Next, the second source driver supplies the data signals respectively to a plurality of data lines in a second region of the plurality of regions that is adjacent to the first region. In the case of the second horizontal two-dot inversion driving, the polarity pattern of the data signals is “+, −, −, +, +, . . . , +, +, −” or “−, +, +, −, −, . . . , −, −, +” which is specified by the polarity signal supplied from the controller. In the case where the shift start signal includes the second control signal, the data signals whose polarity pattern is “−, +, +, −, −, . . . , −, −, +” or “+, −, −, +, +, . . . , +, +, −” that is inverted from the polarity pattern specified by the polarity signal are supplied to the plurality of data lines.

Moreover, the second source driver supplies a shift start signal including the first control signal to a third source driver of the plurality of source drivers that is adjacent to the second source driver on the opposite side of the first source driver. That is to say, the odd-numbered source driver outputs the data signals whose polarity pattern in the second horizontal two-dot inversion driving is “+, −, −, +, +, . . . , +, +, −” or “−, +, +, −, −, . . . , −, −, +”, in accordance with the first control signal included in the shift start signal. Moreover, the odd-numbered source driver supplies the shift start signal including the second control signal instead of the first control signal to the next source driver. The even-numbered source driver outputs the data signals whose polarity pattern in the second horizontal two-dot inversion driving is “−, +, +, −, −, . . . , −, −, +” or “+, −, −, +, +, . . . , +, +, −” that is obtained by inverting the polarity pattern “+, −, −, +, +, . . . , +, +, −” or “−, +, +, −, −, . . . , −, −, +”, in accordance with the second control signal included in the shift start signal. Moreover, the even-numbered source driver supplies the shift start signal including the first control signal instead of the second control signal to the next source driver.

As described above, according to the technique described in Japanese Patent Publication JP-2006-47878, in the case of the second horizontal two-dot inversion driving, the odd-numbered source driver transfers the shift start signal including the second control signal that inverts the polarity pattern specified by the polarity signal to the next source driver, and the even-numbered source driver transfers the shift start signal including the first control signal that does not invert the polarity pattern specified by the polarity signal to the next source driver. As a result, the polarity (“+” or “−”) of the data signal supplied to the last data line in the odd-numbered region and the polarity (“+” or “−”) of the data signal supplied to the first data line in the even-numbered region become equal to each other. Therefore, disturbance of regularity of the polarity pattern of the data signals can be suppressed.

### SUMMARY

The inventor of the present application has recognized the following points.

When source drivers are implemented in a liquid crystal display device, the number of outputs may be different among the source drivers due to such constraints as implementation area constraint. Even in this case, it is desirable to resolve the disturbance of regularity of the polarity pattern of the data signals.

In an aspect of the present invention, a liquid crystal display device is provided. The liquid crystal display device has: a plurality of source drivers; and a display panel that is divided into regions whose number is equal to a number of the plurality of source drivers. Each of the plurality of source drivers is supplied with a mode switch signal. The mode switch signal specifies an applied inversion driving method from among horizontal one-dot inversion driving, first horizontal n-dot inversion driving (n is an integer equal to or larger than 2) in which a number of outputs does not disturb regularity of a polarity pattern of data signals, and second horizontal n-dot inversion driving in which a number of outputs disturbs regularity of a polarity pattern of data signals. Each of the plurality of source drivers has: a driver section and a signal transfer section. The driver section is configured to supply data signals to a plurality of data lines in a corresponding one of the regions. A polarity pattern of the data signals supplied to the plurality of data lines depends on a polarity signal and the applied inversion driving method specified by the mode switch signal. The signal transfer section is configured to supply the polarity signal to a next source driver if the mode switch signal specifies the horizontal one-dot inversion driving or the first horizontal n-dot inversion driving and to supply the polarity signal whose polarity is inverted to the next source driver if the mode switch signal specifies the second horizontal n-dot inversion driving.

In another aspect of the present invention, a method of operating a liquid crystal display device is provided. The liquid crystal display has: a plurality of source drivers; and a display panel that is divided into regions whose number is equal to a number of the plurality of source drivers. The method includes: supplying each of the plurality of source drivers with a mode switch signal, wherein the mode switch signal specifies an applied inversion driving method from among horizontal one-dot inversion driving, first horizontal n-dot inversion driving (n is an integer equal to or larger than 2) in which a number of outputs does not disturb regularity of a polarity pattern of data signals, and second horizontal n-dot inversion driving in which a number of outputs disturbs regularity of a polarity pattern of data signals; supplying, by each of the plurality of source drivers, data signals to a plurality of data lines in a corresponding one of the regions, wherein a polarity pattern of the data signals supplied to the plurality of data lines depends on a polarity signal and the applied inversion driving method specified by the mode switch signal; supplying, by each of the plurality of source drivers, the polarity signal to a next source driver, if the mode switch signal specifies the horizontal one-dot inversion driving or the first horizontal n-dot inversion driving; and supplying, by each of the plurality of source drivers, the polarity signal whose polarity is inverted to the next source driver, if the mode switch signal specifies the second horizontal n-dot inversion driving.

According to an embodiment of the present invention, in a case where a source driver (3-J) (J=1, 2, . . . , (N−1)) is supplied with the mode switch signal (DOTC=“L”, OSEL=“L”) that specifies the horizontal one-dot inversion driving in accordance with specification, the source driver (3-J) executes the horizontal one-dot inversion driving depending on the polarity signal (POL) and further supplies the polarity signal (POL) to the next source driver (3-(J+1)). In a case where the source driver (3-J) is supplied with the mode switch signal (DOTC=“H”, OSEL=“L”) that specifies the first horizontal n-dot inversion driving in accordance with the specification, the source driver (3-J) executes the first horizontal n-dot inversion driving depending on the polarity signal (POL) and further supplies the polarity signal (POL) to the next source driver (3-(J+1)). In a case where the source driver (3-J) is supplied with the mode switch signal (DOTC=“H”, OSEL=“H”) that specifies the second horizontal n-dot inversion driving in accordance with the specification, the source driver (3-J) executes the second horizontal n-dot inversion driving depending on the polarity signal (POL) and further inverts the polarity of the polarity signal (POL) and then supplies the polarity signal (POL) to the next source driver (3-(J+1)).

In this manner, according to the embodiment of the present invention, each of the plurality of source drivers (3-1, 3-2, 3-3, . . . , 3-N) is supplied with the mode switch signal (DOTC, OSEL) in accordance with the specification. Thereby, each source driver can execute the applied inversion driving method that is specified from among the horizontal one-dot inversion driving, the first horizontal n-dot inversion driving and the second horizontal n-dot inversion driving.

Moreover, according to the embodiment of the present invention, in a case where a source driver (3-J) executes the second horizontal n-dot inversion driving, the source driver (3-J) supplies the data signals whose polarity pattern (“−, +, +, −, +” or “+, −, −, +, +, −” if n is 2) is specified by the polarity signal (POL: “L” or “H”) to a corresponding region (4-J). Furthermore, the source driver (3-J) inverts the polarity of the polarity signal (POL) and then supplies the polarity signal (POL: “H” or “L”) to the next source driver (3-(J+1)). In a case where the next source driver (3-(J+1)) executes the horizontal one-dot inversion driving, the next source driver (3-(J+1)) supplies the data signals whose polarity pattern (“+, −, +, −, +, −, +, −, +, −, +, −” or “−, +, −, +, −, +, −, +, −, +, −, +”) is specified by the polarity signal (POL: “H” or “L”) to a corresponding region (4-(J+1)) and further supplies the polarity signal (POL: “H” or “L”) to the further next source driver. In a case where the next source driver (3-(J+1)) executes the first horizontal n-dot inversion driving, the next source driver (3-(J+1)) supplies the data signals whose polarity pattern (“+, −, −, +, +, −, −, +, +, −, −, +” or “−, +, +, −, −, +, +, −, −, +, +, −” if n is 2) is specified by the polarity signal (POL: “H” or “L”) to a corresponding region (4-(J+1)) and further supplies the polarity signal (POL: “H” or “L”) to the further next source driver. In a case where the next source driver (3-(J+1)) executes the second horizontal n-dot inversion driving, the next source driver (3-(J+1)) supplies the data signals whose polarity pattern (“+, −, −, +, +, −” or “−, +, +, −, −, +” if n is 2) is specified by the polarity signal (POL: “H” or “L”) to a corresponding region (4-(J+1)), inverts the polarity of the polarity signal (POL) and then supplies the polarity signal (POL: “L” or “H”) to the further next source driver.

In this manner, according to the embodiment of the present invention, the source driver (3-J), when executing the second horizontal n-dot inversion driving, transfers the polarity signal (POL) to the next source driver (3-(J+1)) after inverting the polarity of the polarity signal (POL). As a result, regarding a boundary division between the region (4-J) and the region (4-(J+1)) in the display panel (10), the polarity (“+” or “−”) of the data signal supplied to the last data line in the region (4-J) by the second horizontal n-dot inversion driving and the polarity (“+” or “−”) of the data signal supplied to the first data line in the region (4-(J+1)) by the horizontal one-dot inversion driving, the first horizontal n-dot inversion driving or the second horizontal n-dot inversion driving become equal to each other. Therefore, disturbance of regularity of the polarity pattern of the data signals can be suppressed.

Furthermore, according to the embodiment of the present invention, the source driver (3-J) transfers the polarity signal (POL) to the next source driver (3-(J+1)). Therefore, the number of signal lines can be reduced as compared with a case where the polarity signal (POL) is supplied from the controller (1) to each source driver.

The present invention can support the case where the number of outputs is different among the plurality of source drivers. Even in this case, it is possible to resolve the disturbance of regularity of the polarity pattern of the data signals.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a configuration of a liquid crystal display device according to an embodiment of the present invention;

FIG. 2 shows a configuration of each of a plurality of source drivers 3-1, 3-2, 3-3, . . . , 3-N;

FIG. 3 shows a relationship between signals (a mode switch signal (DOTC, OSEL) and a polarity signal POL) and polarity patterns of horizontal one-dot inversion driving, first and second horizontal n-dot inversion driving;

FIG. 4 is a schematic diagram for explaining first horizontal two-dot inversion driving in which the number of outputs does not disturb regularity of the polarity pattern of data signals;

FIG. 5 is a schematic diagram for explaining second horizontal two-dot inversion driving in which the number of outputs disturbs regularity of the polarity pattern of data signals;

FIG. 6 shows a configuration of an inversion circuit 40 of a signal transfer section 38 of each of the plurality of source drivers 3-1, 3-2, 3-3, . . . , 3-N; and

FIG. 7 is a conceptual diagram showing an operation of the liquid crystal display device according to the embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A liquid crystal display device according to embodiments of the present invention will be described below in detail with reference to the attached drawings.

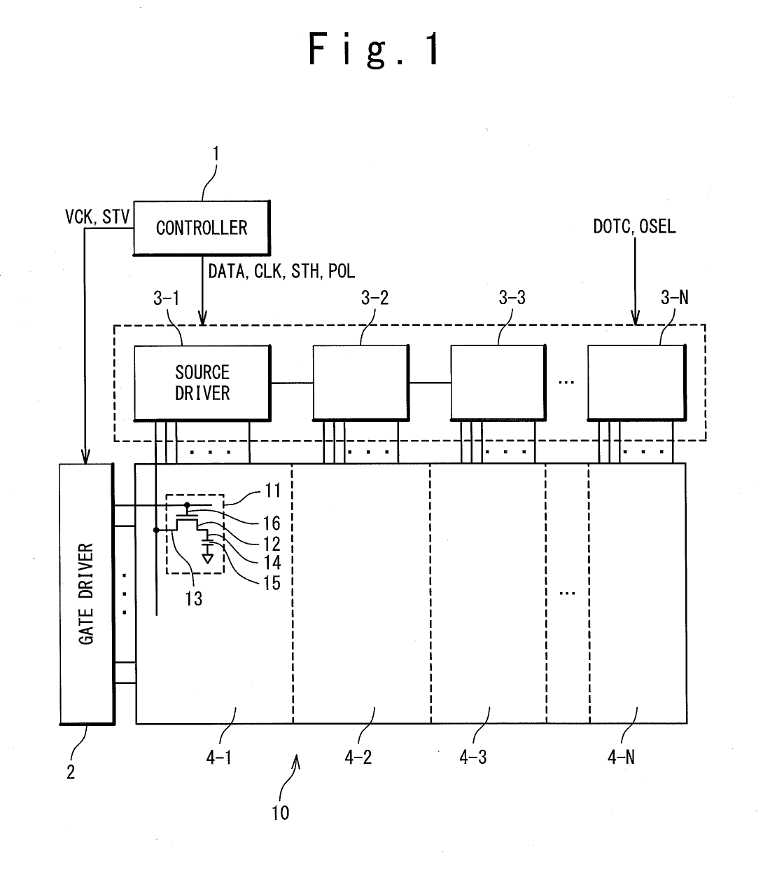

FIG. 1 shows a configuration of a liquid crystal display device according to an embodiment of the present invention.

The liquid crystal display device according to the present embodiment has a display panel (liquid crystal panel) 10 being an LCD (Liquid Crystal Display) module, a controller 1, a gate driver 2 and a plurality of source drivers 3-1, 3-2, 3-3, . . . , 3-N that are cascade connected.

The display panel 10 is divided into a plurality of regions 4-1, 4-2, 4-3, . . . , 4-N whose number is equal to the number of the plurality of source drivers 3-1, 3-2, 3-3, . . . , 3-N.

Each of the plurality of regions 4-1, 4-2, 4-3, . . . , 4-N has a plurality of pixels 11 that are arranged in a matrix form, a plurality of gate lines and a plurality of data lines. Each of the plurality of pixels 11 has a thin film transistor (TFT) 12 and a pixel capacitor 15. The pixel capacitor 15 has a pixel electrode and an opposite electrode facing the pixel electrode. The TFT 12 has a drain electrode 13, a source electrode 14 connected to the pixel electrode and a gate electrode 16. The plurality of gate lines are connected to the gate electrodes 16 of the TFTs 12 of the pixels 11 of respective rows. The plurality of data lines are connected to the drain electrodes 13 of the TFTs 12 of the pixels 11 of respective columns.

In one horizontal period, the controller 1 outputs a vertical clock signal VCK and a vertical shift start signal STV to the gate driver 2. The vertical shift start signal STV is used for selecting the plurality of gate lines in order from the first one to the last one. When the gate driver 2 selects one gate line of the plurality of gate lines in accordance with the vertical shift start signal STV and the vertical clock signal VCK, the gate driver 2 outputs a selection signal to the one gate line. The selection signal is applied to the gate electrodes 16 of the TFTs 12 of the pixels 11 of one scanning line corresponding to the one gate line, and thus the TFTs 12 are turned ON by the selection signal. The same applies to the other gate lines.

The controller 1 outputs gray-scale data DATA for the one scanning line, a clock signal CLK and a shift start signal STH to the source driver 3. The gray-scale data DATA is a digital signal. The clock signal CLK is used for synchronizing the plurality of source drivers 3-1, 3-2, 3-3, . . . , 3-N. The gray-scale data DATA specifies respective gray-scale levels of the plurality of pixels with respect to each of the plurality of regions 4-1, 4-2, 4-3, . . . , 4-N. Based on the shift start signal STH and the clock signal CLK, the source driver 3 outputs gray-scale voltages depending on the gray-scale data DATA to the plurality of data lines, respectively. Since the TFTs 12 of the pixels 11 associated with the one gate line and the plurality of data lines are in the ON states at this time, the gray-scale voltages are respectively applied to the pixel capacitors 15 of the pixels 11. The gray-scale voltages are maintained until the next write operation. Consequently, an image corresponding to the gray-scale data DATA is displayed.

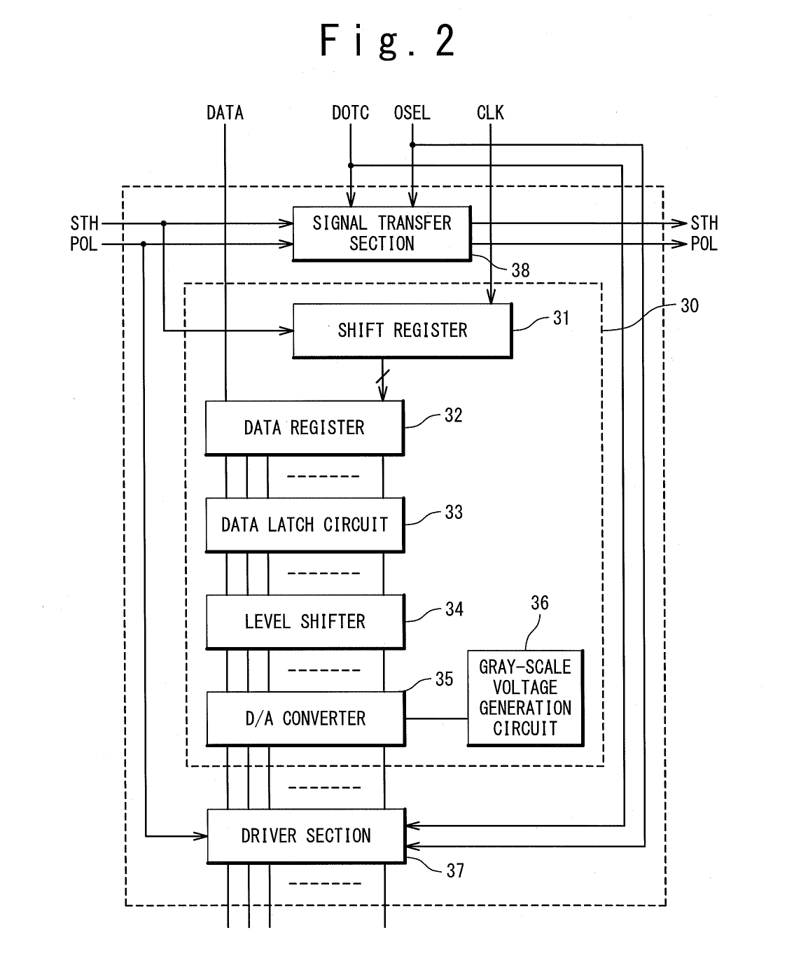

FIG. 2 shows a configuration of each of the plurality of source drivers 3-1, 3-2, 3-3, . . . , 3-N. Each of the plurality of source drivers 3-1, 3-2, 3-3, . . . , 3-N has a signal control section 30, a driver section 37 and a signal transfer section 38.

The signal control section 30 has a shift register 31, a data register 32, a data latch circuit 33, a level shifter 34, a digital/analog (D/A) converter 35 and a gray-scale voltage generation circuit 36.

The gray-scale voltage generation circuit 36 has gray-scale resistance elements that are connected in series. The gray-scale voltage generation circuit 36 voltage-divides, by using the gray-scale resistance elements, a reference voltage received from a power supply circuit (not shown) to generates a plurality of gray-scale voltages.

The shift register 31 shifts the shift start signal STH in synchronization with the clock signal CLK and outputs the shift start signal STH to the data register 32. The data register 32 takes the gray-scale data DATA supplied from the controller 1 in synchronization with the shift start signal STH received from the shift register 31 and outputs the gray-scale data DATA to the data latch circuit 33.

The data latch circuit 33 latches the gray-scale data DATA at a same timing and outputs the latched gray-scale data DATA to the level shifter 34.

The level shifter 34 converts voltage level of the gray-scale data DATA received from the data latch circuit 33 and then outputs the gray-scale data DATA to the D/A converter 35.

The D/A converter 35 D/A converts the gray-scale data DATA received from the level shifter 34 into output gray-scale voltages (analog signal) for the one scanning line, and outputs the gray-scale voltages for the one scanning line to the driver section 37. That is, the D/A converter 35 selects the output gray-scale voltages depending on the gray-scale data DATA from the plurality of gray-scale voltages generated by the gray-scale voltage generation circuit 36, and determines the grays-scale voltages as data signals output by the driver section 37. The D/A converter 35 outputs the data signals to the driver section 37.

The driver section 37 has a plurality of output amplifier sections. Outputs of the plurality of output amplifier sections are respectively connected to the plurality of data lines. The driver section 37 supplies the data signals respectively to the plurality of data lines. Here, a polarity pattern of the data signals supplied to the plurality of data lines depends on a polarity signal POL. A polarity of the polarity signal POL specifies the polarity pattern of the data signals with respect to each line.

Meanwhile, the signal transfer section 38 transfers the shift start signal STH and the polarity signal POL to the next source driver. Therefore, according to the liquid crystal display device of the present embodiment, the number of signal lines can be reduced as compared with a case where the polarity signal POL and the shift start signal STH are supplied from the controller 1 to each source driver 3.

In the present embodiment, the number of outputs can be different among the source drivers 3-1, 3-2, 3-3, . . . , 3-N, in accordance with specification. In order to support this case, the driver section 37 and the signal transfer section 38 of each of the source drivers 3-1, 3-2, 3-3, . . . , 3-N are beforehand supplied with a mode switch signal (DOTC, OSEL). Polarity of the mode switch signal (DOTC, OSEL) is fixed with respect to each source driver 3 in accordance with the specification, as will be described later.

The specification is as follows. As described before, the inversion driving method roughly includes two types: the horizontal one-dot inversion driving and the horizontal n-dot inversion driving. In the case of the horizontal one-dot inversion driving, the polarity of the data signal is inverted every one pixel within a single line. In the case of the horizontal n-dot inversion driving, the polarity of the data signal is inverted every n pixels within a single line (n is an integer equal to or larger than 2). Moreover, the horizontal one-dot inversion driving includes the “first horizontal n-dot inversion driving” in which the number of outputs does not disturb regularity of the polarity pattern of the data signals and the “second horizontal n-dot inversion driving” in which the number of outputs disturbs regularity of the polarity pattern of the data signals.

Next, the mode switch signal (DOTC, OSEL) will be described. The mode switch signal (DOTC, OSEL) specifies an inversion driving method applied to the corresponding source driver 3 from among the horizontal one-dot inversion driving, the first horizontal n-dot inversion driving and the second horizontal n-dot inversion driving.

More specifically, the mode switch signal (DOTC, OSEL) includes an inversion mode switch signal DOTC and a number-of-outputs mode switch signal OSEL.

The inversion mode switch signal DOTC indicates whether an inversion driving method applied to the corresponding source driver 3 is the horizontal one-dot inversion driving or the horizontal n-dot inversion driving. More specifically, in a case where a polarity of the inversion mode switch signal DOTC is the Low level “L”, it specifies the horizontal one-dot inversion driving as the driving method. In a case where the polarity of the inversion mode switch signal DOTC is the High level “H”, it specifies the horizontal n-dot inversion driving (n is an integer equal to or larger than 2) as the driving method.

On the other hand, the number-of-outputs mode switch signal OSEL indicates whether or not the number of outputs of the corresponding source driver 3 disturbs regularity of the polarity pattern of the data signals in the horizontal n-dot inversion driving. More specifically, in a case where a polarity of the number-of-outputs mode switch signal OSEL is the Low level “L”, it indicates that the number of outputs does not disturb regularity of the polarity pattern of the data signals (first horizontal n-dot inversion driving). In a case where the polarity of the number-of-outputs mode switch signal OSEL is the High level “H”, it indicates that the number of outputs disturbs regularity of the polarity pattern of the data signals (second horizontal n-dot inversion driving).

That is, when the respective polarities of the mode switch signals DOTC and OSEL are “L” and “L”, it specifies the horizontal one-dot inversion driving. When the respective polarities of the mode switch signals DOTC and OSEL are “H” and “L”, it specifies the first horizontal n-dot inversion driving. When the respective polarities of the mode switch signals DOTC and OSEL are “H” and “H”, it specifies the second horizontal n-dot inversion driving.

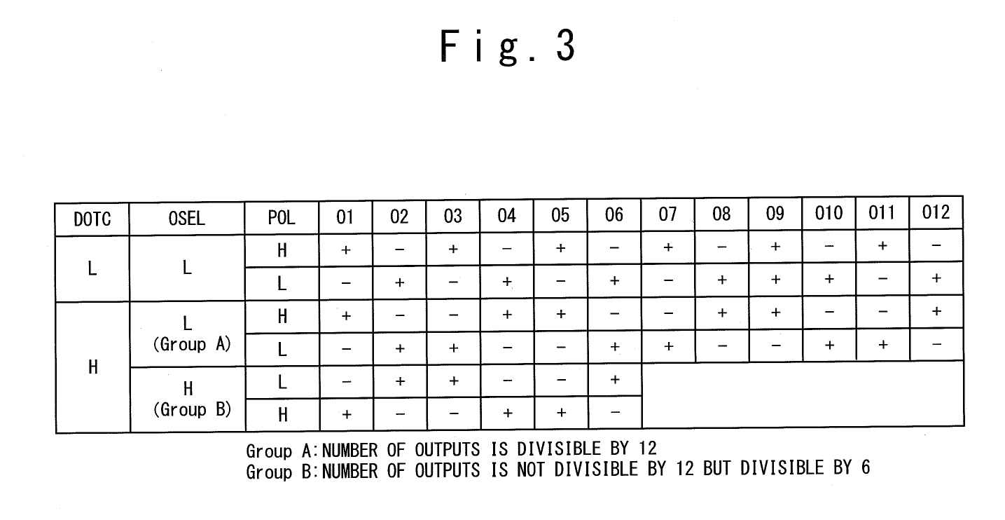

FIG. 3 shows a relationship between the signals (the mode switch signals DOTC and OSEL and the polarity signal POL) and polarity patterns of the horizontal one-dot inversion driving, the first and second horizontal n-dot inversion driving.

Let us consider a case where n is 2. Considering RGB×2 and the horizontal one-dot inversion driving, the number of outputs is preferably an even number. Moreover, in a horizontal two-dot inversion driving, there may exist output polarity continuity by four outputs, which is also taken into consideration. In this case, for example, the number of outputs in the case of the first horizontal n-dot inversion driving is a number divisible by 12 which does not disturb regularity of the polarity pattern of the data signals. On the other hand, the number of outputs in the case of the second horizontal n-dot inversion driving is a number that is not divisible by 12 but divisible by 6 and which disturbs regularity of the polarity pattern of the data signals.

When the respective polarities of the mode switch signals DOTC and OSEL are “L” and “L”, it specifies the horizontal one-dot inversion driving. In a case where the polarity of the polarity signal POL is the Low level “L”, the polarity pattern in the horizontal one-dot inversion driving is “−, +, −, +, −, +, −, +, −, +, −, +”. In a case where the polarity of the polarity signal POL is the High level “H”, the polarity pattern in the horizontal one-dot inversion driving is “+, −, +, −, +, −, +, −, +, −, +, −” opposite to the above one.

When the respective polarities of the mode switch signals DOTC and OSEL are “H” and “L”, it specifies the first horizontal n-dot inversion driving. In a case where the polarity of the polarity signal POL is the Low level “L”, the polarity pattern in the first horizontal two-dot inversion driving is “−, +, +, −, −, +, +, −, −, +, +, −”. In a case where the polarity of the polarity signal POL is the High level “H”, the polarity pattern in the first horizontal two-dot inversion driving is “+, −, −, +, +, −, −, +, +, −, −, +” opposite to the above.

When the respective polarities of the mode switch signals DOTC and OSEL are “H” and “H”, it specifies the second horizontal n-dot inversion driving. In a case where the polarity of the polarity signal POL is the Low level “L”, the polarity pattern in the second horizontal two-dot inversion driving is “−, +, +, −, −, +”. In a case where the polarity of the polarity signal POL is the High level “H”, the polarity pattern in the second horizontal two-dot inversion driving is “+, −, −, +, +, −” opposite to the above. In this manner, the mode switch signal (DOTC, OSEL) specifies the applied inversion driving method from among the horizontal one-dot inversion driving, the first horizontal two-dot inversion driving and the second horizontal two-dot inversion driving. The polarity pattern of the data signals depends on the polarity signal POL and the applied inversion driving method specified by the mode switch signal (DOTC, OSEL). The driver section 37 supplies the data signals with the specified polarity pattern to the plurality of data lines.

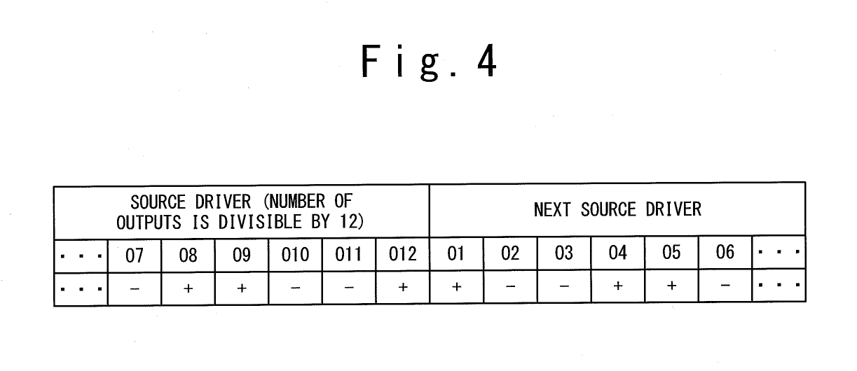

Here, let us consider a case where the polarity of the polarity signal POL is the High level “H”, as an example. In this case, regarding a boundary division between the first region 4-1 and the second region 4-2 in the display panel 10, the polarity “+” of the data signal supplied to the last data line in the first region 4-1 by the first horizontal two-dot inversion driving and the polarity “+” of the data signal supplied to the first data line in the second region 4-2 by the horizontal one-dot inversion driving or the first horizontal two-dot inversion driving or the second horizontal two-dot inversion driving become equal to each other. For example, as shown in FIG. 4, the polarity “+” of the data signal supplied to the last data line in the first region 4-1 by the first horizontal two-dot inversion driving and the polarity “+” of the data signal supplied to the first data line in the second region 4-2 by the first horizontal two-dot inversion driving become equal to each other. Thus, even when the horizontal one-dot inversion driving or the first horizontal two-dot inversion driving or the second horizontal two-dot inversion driving is executed after the first horizontal two-dot inversion driving, it does not cause disturbance of regularity of the polarity pattern of the data signals.

However, regarding the boundary division between the first region 4-1 and the second region 4-2 in the display panel 10, the polarity “−” of the data signal supplied to the last data line in the first region 4-1 by the “second horizontal two-dot inversion driving” and the polarity “+” of the data signal supplied to the first data line in the second region 4-2 by the first horizontal two-dot inversion driving or the second horizontal two-dot inversion driving are different from each other. For example, the polarity “−” of the data signal supplied to the last data line in the first region 4-1 by the second horizontal two-dot inversion driving and the polarity “+” of the data signal supplied to the first data line in the second region 4-2 by the first horizontal two-dot inversion driving are different from each other. Thus, when the first horizontal two-dot inversion driving or the second horizontal two-dot inversion driving is executed after the second horizontal two-dot inversion driving, it causes disturbance of regularity of the polarity pattern of the data signals.

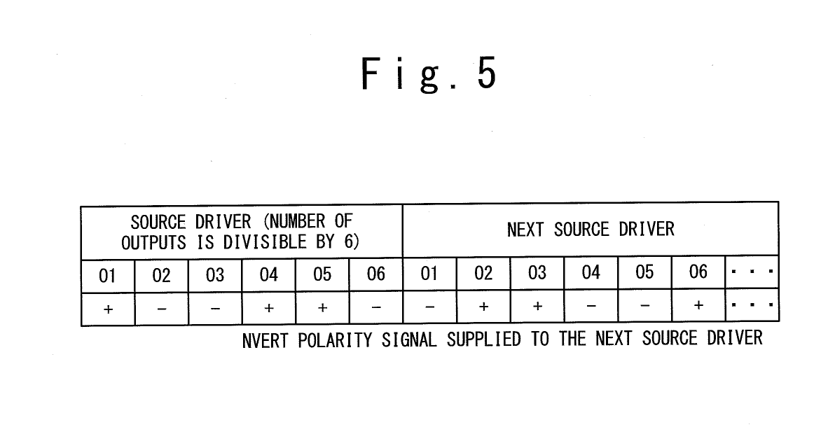

Therefore, according to the present embodiment, as shown in FIG. 5, when the second horizontal two-dot inversion driving is performed, the polarity signal POL is transferred to the next source driver 3 after the polarity of the polarity signal POL is inverted. More specifically, in the case where the driver section 37 executes the horizontal one-dot inversion driving or the first horizontal two-dot inversion driving, the signal transfer section 38 transfers the polarity signal POL to the next source driver 3 without changing the polarity of the polarity signal POL. On the other hand, in the case where the driver section 37 executes the second horizontal two-dot inversion driving, the signal transfer section 38 transfers the polarity signal POL to the next source driver 3 with changing the polarity of the polarity signal POL.

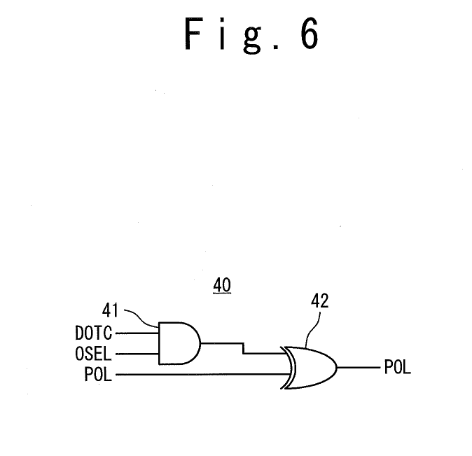

In order to achieve the above-described control, the signal transfer section 38 has an inversion circuit 40 as shown in FIG. 6 for example. The inversion circuit 40 shown in FIG. 6 has a AND circuit 41 and a XOR circuit 42. The inversion mode switch signal DOTC and the number-of-outputs mode switch signal OSEL are input to the AND circuit 41. An output of the AND circuit 41 and the polarity signal POL are input to the XOR circuit 42. An output of the XOR circuit 42 is connected to the inversion circuit 40 of the signal transfer section 38 of the next source driver.

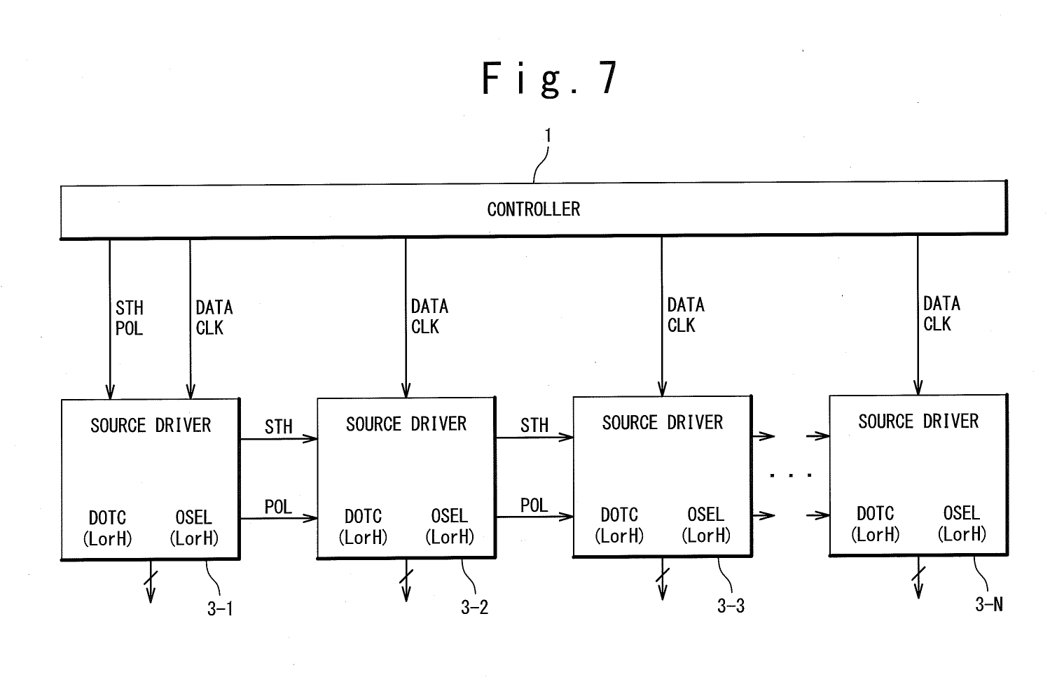

FIG. 7 is a conceptual diagram showing an operation of the liquid crystal display device according to the embodiment of the present invention.

The controller 1 supplies the shift start signal STH and the polarity signal POL to a first source driver 3-1 of the plurality of source drivers 3-1, 3-2, 3-3, . . . , 3-N.

In response to the shift start signal STH supplied from the controller 1, the signal control section 30 of the first source driver 3-1 takes the gray-scale data DATA supplied from the controller 1 as a first gray-scale data, and converts the first gray-scale data into the output gray-scale voltages as the data signals output from the first source driver 3-1 to the plurality of the data lines.

Here, let us consider a case where the mode switch signal specifies the horizontal one-dot inversion driving (DOTC=“L”, OSEL=“L”). In this case, the driver section 37 of the first source driver 3-1 supplies the data signals to the plurality of data lines in the first region 4-1 of the plurality of regions 4-1, 4-2, 4-3, . . . , 4-N. The polarity pattern of the data signals supplied to the first region 4-1 is “−, +, 31 , +, −, +, −, +, −, +, −, +” or “+, −, +, −, +, −, +, −, +, −, +, −, ” depending on the polarity (“L” or “H”) of the polarity signal POL supplied from the controller 1. Moreover, the signal transfer section 38 of the first source driver 3-1 supplies the shift start signal STH and the polarity signal POL to a second source driver 3-2 of the plurality of source drivers 3-1, 3-2, 3-3, . . . , 3-N that is adjacent to the first source driver 3-1.

Let us consider another case where the mode switch signal specifies the first horizontal two-dot inversion driving (DOTC=“H”, OSEL=“L”). In this case, the driver section 37 of the first source driver 3-1 supplies the data signals to the plurality of data lines in the first region 4-1. The polarity pattern of the data signals supplied to the first region 4-1 is “−, +, +, −, −, +, +, −, −, +, +, −” or “+, −, −, +, +, −, −, +, +, −, −, +” depending on the polarity (“L” or “H”) of the polarity signal POL supplied from the controller 1. Moreover, the signal transfer section 38 of the first source driver 3-1 supplies the shift start signal STH and the polarity signal POL to the second source driver 3-2.

Let us consider still another case where the mode switch signal specifies the second horizontal two-dot inversion driving (DOTC=“H”, OSEL=“H”). In this case, the driver section 37 of the first source driver 3-1 supplies the data signals to the plurality of data lines in the first region 4-1. The polarity pattern of the data signals supplied to the first region 4-1 is “−, +, +, −, −, +” or “+, −, −, +, +, −” depending on the polarity (“L” or “H”) of the polarity signal POL supplied from the controller 1. Moreover, the signal transfer section 38 of the first source driver 3-1 inverts the polarity of the polarity signal POL (“L” or “H”) and then supplies the shift start signal STH and the polarity signal POL (“H” or “L”) to the second source driver 3-2.

In response to the shift start signal STH supplied from the first source driver 3-1, the signal control section 30 of the second source driver 3-2 takes the gray-scale data DATA supplied from the controller 1 as a second gray-scale data, and converts the second gray-scale data into the output gray-scale voltages as the data signals output from the second source driver 3-2 to the plurality of the data lines.

Here, let us consider a case where the mode switch signal specifies the horizontal one-dot inversion driving (DOTC=“L”, OSEL=“L”). In this case, the driver section 37 of the second source driver 3-2 supplies the data signals to the plurality of data lines in the second region 4-2 of the plurality of regions 4-1, 4-2, 4-3, . . . , 4-N that is adjacent to the first region 4-1. The polarity pattern of the data signals supplied to the second region 4-2 is “−, +, −, +, −, +, −, +, −, +, −, +” or “+, −, +, −, +, −, +, −, +, −, +, −” depending on the polarity (“L” or “H”) of the polarity signal POL supplied from the first source driver 3-1. Moreover, the signal transfer section 38 of the second source driver 3-2 supplies the shift start signal STH and the polarity signal POL to a third source driver 3-3 of the plurality of source drivers 3-1, 3-2, 3-3, . . . , 3-N that is adjacent to the second source driver 3-2 on the opposite side of the first source driver 3-1.

Let us consider another case where the mode switch signal specifies the first horizontal two-dot inversion driving (DOTC=“H”, OSEL=“L”). In this case, the driver section 37 of the second source driver 3-2 supplies the data signals to the plurality of data lines in the second region 4-2. The polarity pattern of the data signals supplied to the second region 4-2 is “−, +, +, −, −, +, +, −, −, +, +, −” or “+, −, −, +, +, −, −, +, +, −, −, +” depending on the polarity (“L” or “H”) of the polarity signal POL supplied from the first source driver 3-1. Moreover, the signal transfer section 38 of the second source driver 3-2 supplies the shift start signal STH and the polarity signal POL to the third source driver 3-3.

Let us consider still another case where the mode switch signal specifies the second horizontal two-dot inversion driving (DOTC=“H”, OSEL=“H”). In this case, the driver section 37 of the second source driver 3-2 supplies the data signals to the plurality of data lines in the second region 4-2. The polarity pattern of the data signals supplied to the second region 4-2 is “−, +, +, −, −, +” or “+, −, −, +, +, −” depending on the polarity (“L” or “H”) of the polarity signal POL supplied from the first source driver 3-1. Moreover, the signal transfer section 38 of the second source driver 3-2 inverts the polarity of the polarity signal POL (“L” or “H”) and then supplies the shift start signal STH and the polarity signal POL (“H” or “L”) to the third source driver 3-3.

According to the embodiment of the present invention, in a case where a source driver 3-J (J=1, 2, . . . , (N−1)) is supplied with the mode switch signal (DOTC=“L”, OSEL=“L”) that specifies the horizontal one-dot inversion driving in accordance with specification, the source driver 3-J executes the horizontal one-dot inversion driving depending on the polarity signal POL and further supplies the polarity signal POL and the shift start signal STH to the next source driver 3-(J+1). In a case where the source driver 3-J is supplied with the mode switch signal (DOTC=“H”, OSEL=“L”) that specifies the first horizontal n-dot inversion driving in accordance with the specification, the source driver 3-J executes the first horizontal n-dot inversion driving depending on the polarity signal POL and further supplies the polarity signal POL and the shift start signal STH to the next source driver 3-(J+1). In a case where the source driver 3-J is supplied with the mode switch signal (DOTC=“H”, OSEL=“H”) that specifies the second horizontal n-dot inversion driving in accordance with the specification, the source driver 3-J executes the second horizontal n-dot inversion driving depending on the polarity signal POL and further inverts the polarity of the polarity signal POL and then supplies the polarity signal POL and the shift start signal STH to the next source driver 3-(J+1).

In this manner, according to the embodiment of the present invention, each of the plurality of source drivers 3-1, 3-2, 3-3, . . . , 3-N is supplied with the mode switch signal (DOTC, OSEL) in accordance with the specification. Thereby, each source driver can execute the applied inversion driving method that is specified from among the horizontal one-dot inversion driving, the first horizontal n-dot inversion driving and the second horizontal n-dot inversion driving.

Moreover, according to the embodiment of the present invention, in a case where a source driver 3-J executes the second horizontal n-dot inversion driving, the source driver 3-J supplies the data signals whose polarity pattern (“−, +, +, −, −, +” or “+, −, −, +, +, −” if n is 2) is specified by the polarity signal POL (“L” or “H”) to a corresponding region 4-J. Furthermore, the source driver 3-J inverts the polarity of the polarity signal POL and then supplies the polarity signal POL (“H” or “L”) and the shift start signal STH to the next source driver 3-(J+1). In a case where the next source driver 3-(J+1) executes the horizontal one-dot inversion driving, the next source driver 3-(J+1) supplies the data signals whose polarity pattern (“+, −, +, −, +, −, +, −, +, −, +, −” or “−, +, −, +, −, +, −, +, −, +, −, +”) is specified by the polarity signal POL (“H” or “L”) to a corresponding region 4-(J+1) and further supplies the polarity signal POL (“H” or “L”) and the shift start signal STH to the further next source driver. In a case where the next source driver 3-(J+1) executes the first horizontal n-dot inversion driving, the next source driver 3-(J+1) supplies the data signals whose polarity pattern (“+, −−, +, +, −, −, +, +, −, −, +” or “−, +, +, −, −, +, +, −, −, +, +, −” if n is 2) is specified by the polarity signal POL (“H” or “L”) to a corresponding region 4-(J+1) and further supplies the polarity signal POL (“H” or “L”) and the shift start signal STH to the further next source driver. In a case where the next source driver 3-(J+1) executes the second horizontal n-dot inversion driving, the next source driver 3-(J+1) supplies the data signals whose polarity pattern (“+, −, −, +, +, −” or “−, +, +, −, −, +” if n is 2) is specified by the polarity signal POL (“H” or “L”) to a corresponding region 4-(J+1), inverts the polarity of the polarity signal POL and then supplies the polarity signal POL (“L” or “H”) and the shift start signal STH to the further next source driver.

In this manner, according to the embodiment of the present invention, the source driver 3-J, when executing the second horizontal n-dot inversion driving, transfers the polarity signal POL to the next source driver 3-(J+1) after inverting the polarity of the polarity signal POL. As a result, regarding a boundary division between the region 4-J and the region 4-(J+1) in the display panel 10, the polarity (“+” or “−”) of the data signal supplied to the last data line in the region 4-J by the second horizontal n-dot inversion driving and the polarity (“+” or “−”) of the data signal supplied to the first data line in the region 4-(J+1) by the horizontal one-dot inversion driving, the first horizontal n-dot inversion driving or the second horizontal n-dot inversion driving become equal to each other. Therefore, disturbance of regularity of the polarity pattern of the data signals can be suppressed.

Furthermore, according to the embodiment of the present invention, the source driver 3-J transfers the polarity signal POL and the shift start signal STH to the next source driver 3-(J+1). Therefore, the number of signal lines can be reduced as compared with a case where the polarity signal POL and the shift start signal STH are supplied from the controller 1 to each source driver.

The present invention can support the case where the number of outputs is different among the plurality of source drivers 3-1, 3-2, 3-3, . . . , 3-N. Even in this case, it is possible to resolve the disturbance of regularity of the polarity pattern of the data signals.

It is apparent that the present invention is not limited to the above embodiments and may be modified and changed without departing from the scope and spirit of the invention.

What is claimed is:

1. A liquid crystal display device comprising:
a plurality of source drivers each of which is supplied with a mode switch signal, wherein said mode switch signal specifies an applied inversion driving method from among horizontal one-dot inversion driving, first horizontal n-dot inversion driving (n is an integer equal to or larger than 2) in which a number of outputs does not disturb regularity of a polarity pattern of data signals, and second horizontal n-dot inversion driving in which a number of outputs disturbs regularity of a polarity pattern of data signals; and
a display panel that is divided into regions whose number is equal to a number of said plurality of source drivers,
wherein each of said plurality of source drivers comprises:
a driver section configured to supply data signals to a plurality of data lines in a corresponding one of said regions, wherein a polarity pattern of said data signals supplied to said plurality of data lines depends on a polarity signal and said applied inversion driving method specified by said mode switch signal; and
a signal transfer section configured to supply said polarity signal to a next source driver if said mode switch signal specifies said horizontal one-dot inversion driving or said first horizontal n-dot inversion driving and to supply said polarity signal whose polarity is inverted to said next source driver if said mode switch signal specifies said second horizontal n-dot inversion driving.

2. The liquid crystal display device according to claim 1,
wherein each of said plurality of source drivers further comprises a signal control section,
wherein said signal control section takes, in response to a shift start signal, a gray-scale data associated with a plurality of pixels connected to said plurality of data lines, and converts said gray-scale data into output gray-scale voltages as said data signals supplied to said plurality of data lines.

3. The liquid crystal display device according to claim 2,
wherein if said mode switch signal specifies said horizontal one-dot inversion driving or said first horizontal n-dot inversion driving, said signal transfer section of each of said plurality of source drivers supplies said shift start signal and said polarity signal to said next source driver, and
wherein if said mode switch signal specifies said second horizontal n-dot inversion driving, said signal transfer section of each of said plurality of source drivers inverts said polarity of said polarity signal and then supplies said shift start signal and said polarity signal to said next source driver.

4. The liquid crystal display device according to claim 3, further comprising a controller configured to supply said gray-scale data to each of said plurality of source drivers,
wherein said controller supplies said shift start signal and said polarity signal to a first source driver of said plurality of source drivers,
wherein said signal control section of said first source driver takes, in response to said shift start signal supplied from said controller, said gray-scale data supplied from said controller as a first gray-scale data, and converts said first gray-scale data into said output gray-scale voltages as said data signals output from said first source driver,
wherein said driver section of said first source driver supplies said data signals to said plurality of data lines in a first region of said regions,
wherein said polarity pattern of said data signals supplied to said plurality of data lines in said first region depends on said polarity signal supplied from said controller and said applied inversion driving method specified by said mode switch signal,
wherein if said mode switch signal specifies said horizontal one-dot inversion driving or said first horizontal n-dot inversion driving, said signal transfer section of said first source driver supplies said shift start signal and said polarity signal to a second source driver adjacent to said first source driver in said plurality of source drivers, and
wherein if said mode switch signal specifies said second horizontal n-dot inversion driving, said signal transfer section of said first source driver inverts said polarity of said polarity signal and then supplies said shift start signal and said polarity signal to said second source driver.

5. The liquid crystal display device according to claim 4,
wherein said signal control section of said second source driver takes, in response to said shift start signal supplied from said first source driver, said gray-scale data supplied from said controller as a second gray-scale data, and converts said second gray-scale data into said output gray-scale voltages as said data signals output from said second source driver,
wherein said driver section of said second source driver supplies said data signals to said plurality of data lines in a second region of said regions that is adjacent to said first region,
wherein said polarity pattern of said data signals supplied to said plurality of data lines in said second region depends on said polarity signal supplied from said first source driver and said applied inversion driving method specified by said mode switch signal,
wherein if said mode switch signal specifies said horizontal one-dot inversion driving or said first horizontal n-dot inversion driving, said signal transfer section of said second source driver supplies said shift start signal and said polarity signal to a third source driver adjacent to said second source driver in said plurality of source drivers, and
wherein if said mode switch signal specifies said second horizontal n-dot inversion driving, said signal transfer section of said second source driver inverts said polarity of said polarity signal and then supplies said shift start signal and said polarity signal to said third source driver.

6. The liquid crystal display device according to claim 1,
wherein said mode switch signal includes:
an inversion mode switch signal that indicates whether said applied inversion driving method is said horizontal one-dot inversion driving or horizontal n-dot inversion driving; and
a number-of-outputs mode switch signal that indicates whether or not said number of outputs disturbs regularity of said polarity pattern of said data signals in said horizontal n-dot inversion driving.

7. The liquid crystal display device according to claim 1,
wherein said n is 2,
said number of outputs in said first horizontal n-dot inversion driving is a number divisible by 12, and said number of outputs in said second horizontal n-dot inversion driving is a number that is not divisible by 12 but divisible by 6.

8. A method of operating a liquid crystal display device,
said liquid crystal display comprising:
a plurality of source drivers; and
a display panel that is divided into regions whose number is equal to a number of said plurality of source drivers,
said method comprising:
supplying each of said plurality of source drivers with a mode switch signal, wherein said mode switch signal specifies an applied inversion driving method from among horizontal one-dot inversion driving, first horizontal n-dot inversion driving (n is an integer equal to or larger than 2) in which a number of outputs does not disturb regularity of a polarity pattern of data signals, and second horizontal n-dot inversion driving in which a number of outputs disturbs regularity of a polarity pattern of data signals;
supplying, by each of said plurality of source drivers, data signals to a plurality of data lines in a corresponding one of said regions, wherein a polarity pattern of said data signals supplied to said plurality of data lines depends on a polarity signal and said applied inversion driving method specified by said mode switch signal;
supplying, by each of said plurality of source drivers, said polarity signal to a next source driver, if said mode switch signal specifies said horizontal one-dot inversion driving or said first horizontal n-dot inversion driving; and
supplying, by each of said plurality of source drivers, said polarity signal whose polarity is inverted to said next source driver, if said mode switch signal specifies said second horizontal n-dot inversion driving.
